(19) United States
(12) Patent Application Publication
(10) Pub. No.: US 2007/0084121 A1
(43) Pub. Date: Apr. 19, 2007

(54) Building or yard closing apparatus

(75) Inventor: Michael Hoermann, Halle/Westf. (DE)

Correspondence Address: ALLEMAN HALL MCCOY RUSSELL & TUTTLE LLP, 806 SW BROADWAY, SUITE 600, PORTLAND, OR, 97205-3335, US

(73) Assignee: Marantec Antriebs- und Steuerungstechnik GmbH & Co. KG

(21) Appl. No.: 11/546,706

(22) Filed: Oct. 11, 2006

(30) Foreign Application Priority Data
Oct. 13, 2005 (DE) 20 2005 016 087.3

(51) Int. Cl. E05F 15/20

(52) U.S. Cl. 49/31

(57) ABSTRACT

The present disclosure relates to a building or yard closing apparatus such as a gate, a door or a window. In accordance with the present disclosure, at least one sensor is present which detects the location and speed of objects in the surrounding of the movement region.

### CROSS REFERENCE TO RELATED APPLICATION

This application claims priority to German Utility Model Application Serial No. 20 2005 016 087.3, filed Oct. 13, 2005, which is hereby incorporated be reference in its entirety for all purposes.

### FIELD

The present disclosure relates to a building or yard closing apparatus such as a gate, a door or a window.

### BACKGROUND AND SUMMARY

There is a desire to automate building and yard closing apparatus such as gates, doors or windows, i.e. to open or close them automatically. However, there is the problem in the automatic opening and closing that a person or an object can be located in the movement region of the building and yard closing apparatus or that a person or an object can move through the opening and/or closing region of the building and yard closing apparatus. In the case of persons, there is a risk of injury to the persons, whereas on the corresponding moving of objects through or the positioning of objects in the movement region of the building and yard closing apparatus, there is a risk of damage or destruction.

To prevent this, it is known, for example with sectional doors or roller doors, to provide the end edge with a sensor system which detects a contact with an object disposed in the movement region of the door and brings the door closing mechanism to a standstill. A system of this type is, however, not realizable in this form, for example, with a window pivoting open or a door pivoting open.

It is therefore the object of the present disclosure to further develop a building and yard closing apparatus, such as a gate, a door or a window, such that, with a corresponding automation, it reliably prevents a collision with a person or an object standing in or moved through the movement region.

This object is satisfied in accordance with the present disclosure in that the building and yard closing apparatus has at least one sensor which detects the location and speed of objects in the surrounding of the movement region. The danger region around the building and yard closing apparatus is now observed via this sensor system. The danger region is that region which is swept over on an automatic movement of the building and yard closing apparatus. A dynamic detection and evaluation of possible obstacles should take place by this monitoring. The information on the spacing or distance, that is on the location of the obstacle or of the person, the absolute speed of the building and yard closing apparatus and/or the relative speed with respect to the obstacle is used for this purpose.

Additional and/or alternative aspects are also provided in the present disclosure. Accordingly, the building and yard closing apparatus can be driven via a drive motor which can be controlled in accordance with the recorded signals via a signal evaluation unit. This means that the correspondingly recorded signals with respect to the location and to the speed of the object located in the monitored region or of the person present there are subject to an evaluation and that these signals are passed on to the drive motor to stop this as necessary or to slow down or, optionally, accelerate the closing or opening speed transferred to the building or yard closing apparatus to reliably avoid a collision.

The spacing from an obstacle, the absolute speed and/or the relative speed with respect to the obstacle are therefore determined in accordance with the present disclosure via the sensor and the associated signal evaluation unit.

Signals on the reaching of the end positions can also be recorded via the sensor. The respectively currently recorded signals on the reaching of the end position can be compared with stored comparison values.

A self-learning and self-optimizing system can hereby be provided.

Selectively, sensors of radar technology, laser technology, infrared technology, ultrasonic technology and/or video technology can be considered as the sensors. If the laser technology is used, the laser Doppler process can, for example, be used. Generally, all sensors are suitable which can detect the position, i.e. the location, of the object and the speed of the object.

In accordance with a particularly advantageous aspect, the sensor is arranged on the moved apparatus itself. In addition, if required, at least one sensor can be arranged in a stationary manner outside the moved apparatus.

### BRIEF DESCRIPTION OF THE FIGURES

Further features, details and advantages of the present disclosure result from embodiments explained with reference to the drawing. There are shown:

FIG. 1 is a view of a garage door carrying out a swing-leaf movement in a view from the front;

FIG. 2 is the view of FIG. 1 from above in different positions;

FIG. 3 is a front view of a sectional door;

FIG. 4 is the view of FIG. 3 in a sectioned representation from the side; and

FIG. 5A is the view of a sliding gate, and FIG. 5B is a plan view from above the sliding gate.

### DETAILED DESCRIPTION OF THE FIGURES

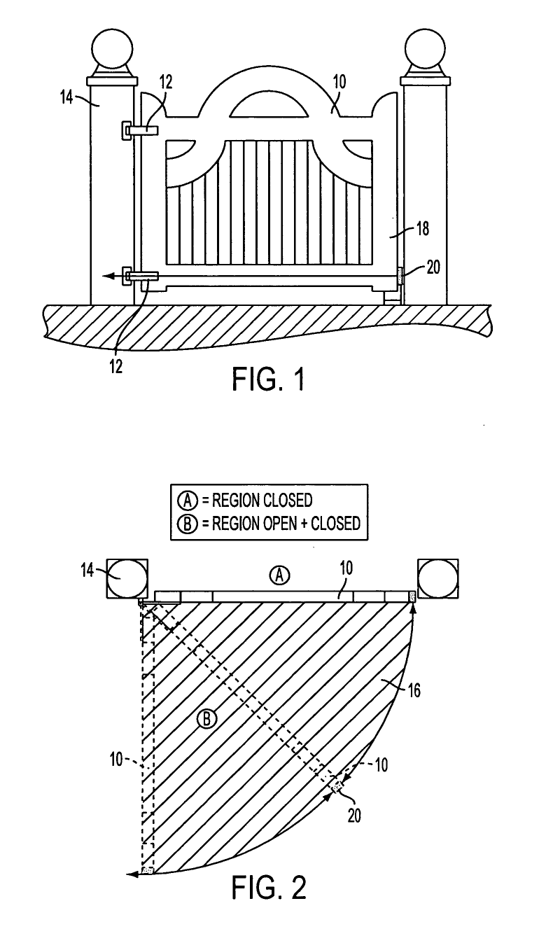

In FIG. 1, a garden gate 10 is shown by way of example which is pivotably hinged to a post 14 at one side around two hinges 12. This garden gate 10 accordingly carries out a swing-leaf movement from a closed position, such as is shown in FIG. 2 by the solid lines, into an open position, such as is reproduced by broken lines in FIG. 2. During the opening or closing, the garden gate 10 sweeps over the region 16 hatched in FIG. 2.

A sensor 20, for example a radar sensor 20, is arranged at the outer edge 18 of the garden gate. The location and the speed of an object or of a person located in the hatched region 16 are detected using this radar sensor 20. In this context, it can be an object stationary in the hatched region or a person stationary in the hatched region or an object moved dynamically through this region or a person walking through this region. The sensor 20 detects the position and speed of the change in position or of the person and reports these signals to a signal evaluation unit not shown in any more detail in FIG. 1 or FIG. 2. The corresponding signal evaluation unit passes the corresponding signals to a drive motor, likewise not shown in the representations of FIG. 1 or FIG. 2, and controls it accordingly to slow down or accelerate the movement of the garden gate 10 such that a collision with the object located in the region 16 is reliably prevented. If it is necessary, the garden gate can also be stopped completely to avoid a collision.

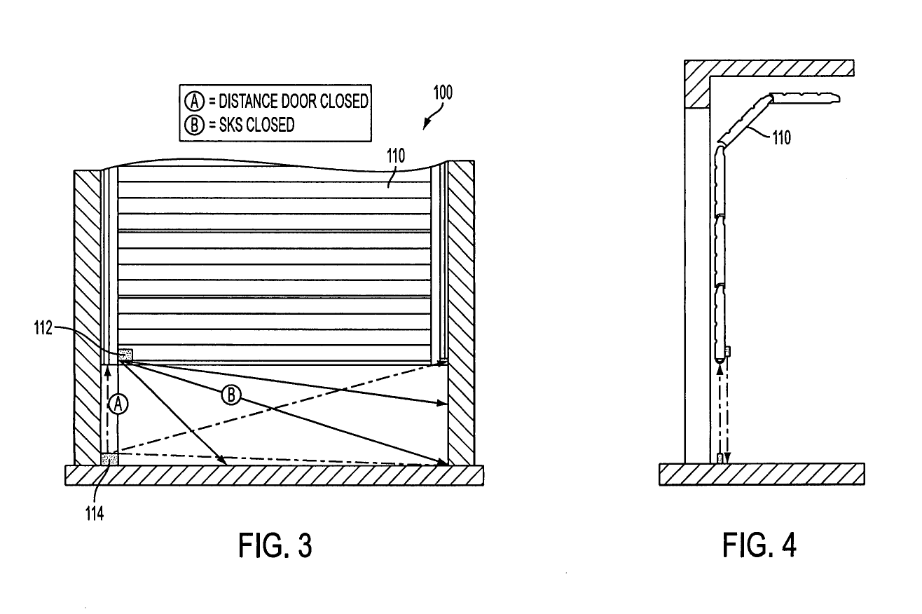

In FIGS. 3 and 4, a garage door 100 in the form of a sectional door 110 is shown at whose lower edge a first sensor 112 is positioned. It is, for example, an ultrasonic sensor which monitors the space beneath the closing door. This is indicated by the beam paths B. A further ultrasonic sensor 114 is arranged in the region of the door frame and continuously detects the distance to the closing door and can compare the closing of the door dynamically with stored historical values. A self-learning and self-optimizing closing system can be realized in this respect. As already shown with respect to the garden gate 10 in the embodiment of FIGS. 1 and 2, the sectional door 110 is also slowed down or stopped when a corresponding object or person is located in or moves through the monitored region.

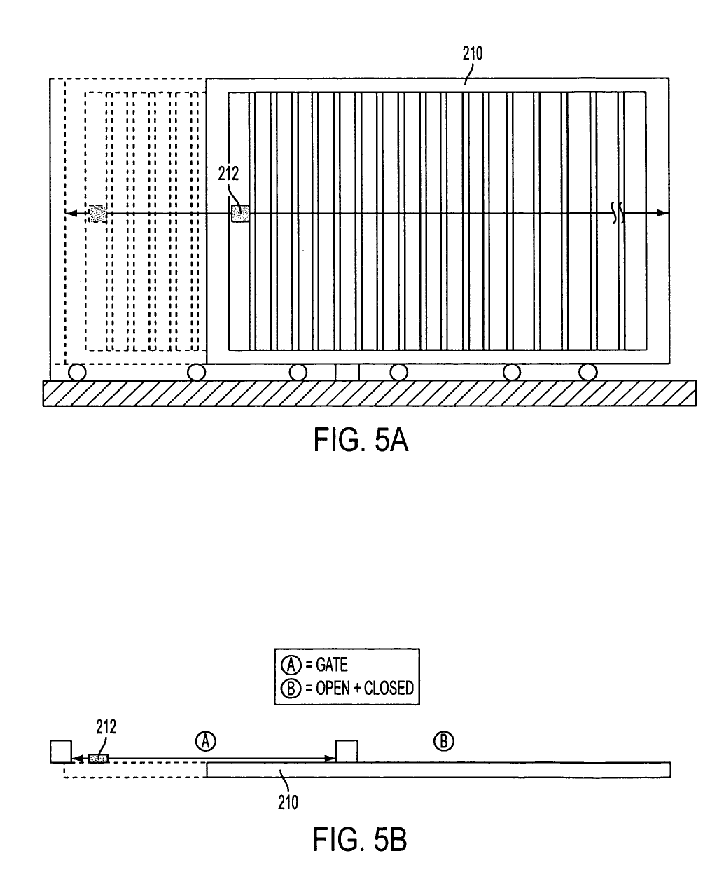

In the embodiment in accordance with FIG. 5, a sliding gate 210 is shown at which a sensor 212 likewise monitors for the monitoring of the location and speed of an object located in the monitored closing region of the sliding gate 210 or of a person correspondingly located there. In this context, not only the region on the closing of the gate is monitored, but also on the opening of the gate in the direct movement region of the gate (region A or B).

1. A building or yard closing apparatus such as a gate, a door or a window,
wherein the building or yard closing apparatus has at least one sensor which detects the location and speed of objects in the surrounding of the movement region.

2. The building and yard closing apparatus in accordance with claim 1, wherein the building or yard closing apparatus is driven by a drive motor which can be controlled via a signal evaluation unit in accordance with the recorded signals.

3. The building and yard closing apparatus in accordance with claim 2, wherein the spacing from an obstacle, the absolute speed and/or the relative speed with respect to the obstacle can be determined via the at least one sensor and the associated signal evaluation unit.

4. The building and yard closing apparatus in accordance with claim 1, wherein signals on the reaching of the end positions can also be recorded via the at least one sensor.

5. The building and yard closing apparatus in accordance with claim 4, wherein the currently recorded signals for the reaching of an end position are comparable with stored comparison values.

6. The building and yard closing apparatus in accordance with claim 1, wherein the sensors are based on radar technology, laser technology, infrared technology, ultrasound technology and/or video technology.

7. The building and yard closing apparatus in accordance with claim 1, wherein the at least one sensor is arranged on the moved apparatus.

8. The building and yard closing apparatus in accordance with claim 7, wherein at least one sensor is additionally arranged in a stationary manner outside the moved apparatus.
